(19) United States
(12) Patent Application Publication
(10) Pub. No.: US 2010/0299099 A1
(43) Pub. Date: Nov. 25, 2010

(54) AIR CONDITIONING ABNORMALITY DETECTION APPARATUS AND METHOD

(75) Inventors: Nobuyoshi YAMAOKA, Kawasaki (JP); Junichi ISHIMINE, Kawasaki (JP); Ikuro NAGAMATSU, Kawasaki (JP); Masahiro SUZUKI, Kawasaki (JP); Tadashi KATSUI, Kawasaki (JP); Yuji OHBA, Kawasaki (JP); Seiichi SAITO, Kawasaki (JP); Akira UEDA, Kawasaki (JP); Yasushi URAKI, Kawasaki (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: FUJITSU LIMITED, Kawasaki-shi (JP)

(21) Appl. No.: 12/782,888

(22) Filed: May 19, 2010

(30) Foreign Application Priority Data
May 21, 2009 (JP) 2009-123525

(51) Int. Cl. G06F 15/00; F25B 49/00; G06N 5/02; G01K 13/00

(52) U.S. Cl. 702/130; 62/129; 706/54; 702/183

(57) ABSTRACT

An abnormality detection apparatus for detecting abnormality of air conditioning in a room which accommodates a plurality of computers having an air inlet and having an outlet, includes, a plurality of temperature detectors for detecting temperatures at each of the air inlets, a memory for storing a plurality of reference patterns, each of the reference patterns representing a set of temperatures at each of the air inlets and corresponding to one of a plurality of abnormal categories, a determining unit for determining one of the abnormal categories by comparing the detected temperatures by the temperature detectors with the reference patterns stored in the memory, an output unit for outputting information corresponding to the category of the air condition abnormality determined.

### CROSS-REFERENCE TO RELATED APPLICATIONS

This application is based upon and claims the benefit of priority of the prior Japanese Patent Application No. 2009-123525, filed on May 21, 2009, the entire contents of which are incorporated herein by reference.

### FIELD

The embodiment discussed herein is related to an air conditioning abnormality detection apparatus and method.

### BACKGROUND

In recent years, as the performance of information processing apparatus increases, an increase of heat generated from information processing apparatus has become a serious problem. In particular, in a data center or a computer room in which many information processing apparatuses are installed, temperature may easily exceed an allowable temperature on account of the increase of heat generated from the information processing apparatuses.

To solve the problem described above, a technique to prevent a temperature in a computer room from exceeding an allowable temperature by monitoring the room temperature, and automatically starting cooling operation before the temperature exceeds an upper limit value is proposed.

Japanese Laid-open Patent Publication No. 2007-170686 is an example of related art.

However, since an air conditioner is controlled by the above conventional technique by simply determining the room temperature on the basis of a threshold value, it is not always possible to appropriately cope with an occurring situation. This is because there are various causes that raise the room temperature in a data center or a computer room, and it is not possible to obtain a satisfying result unless the causes are identified and appropriate action is taken.

### SUMMARY

According to an aspect of the embodiment, An abnormality detection apparatus for detecting abnormality of air conditioning in a room which accommodates a plurality of computers having an air inlet and having an outlet, includes, a plurality of temperature detectors for detecting temperatures at each of the air inlets, a memory for storing a plurality of reference patterns, each of the reference patterns representing a set of temperatures at each of the air inlets and corresponding to one of a plurality of abnormal categories, a determining unit for determining one of the abnormal categories by comparing the detected temperatures by the temperature detectors with the reference patterns stored in the memory, an output unit for outputting information corresponding to the category of the air condition abnormality determined.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a data center including a monitoring apparatus according to an embodiment.

FIG. 2 is a functional block diagram illustrating a configuration of the monitoring apparatus according to the embodiment.

FIG. 3 is a diagram illustrating an example of exhaust air 2001 circulation flow.

FIG. 4 is a diagram illustrating an example of weight setting and temperature rise.

FIG. 5 is a graph illustrating an example of temperature rise.

FIG. 6 is a diagram illustrating another example of exhaust air 2001 circulation flow.

FIG. 7 is a diagram illustrating another example of weight setting and temperature rise.

FIG. 8 is a graph illustrating another example of temperature rise.

FIG. 9 is a flowchart illustrating a processing procedure of temperature monitoring processing.

FIG. 10 is a functional block diagram illustrating a computer which executes a monitoring program.

### DESCRIPTION OF EMBODIMENT

Hereinafter, an embodiment of a monitoring apparatus, a monitoring program, and a monitoring method disclosed by the present application will be described in detail with reference to the drawings.

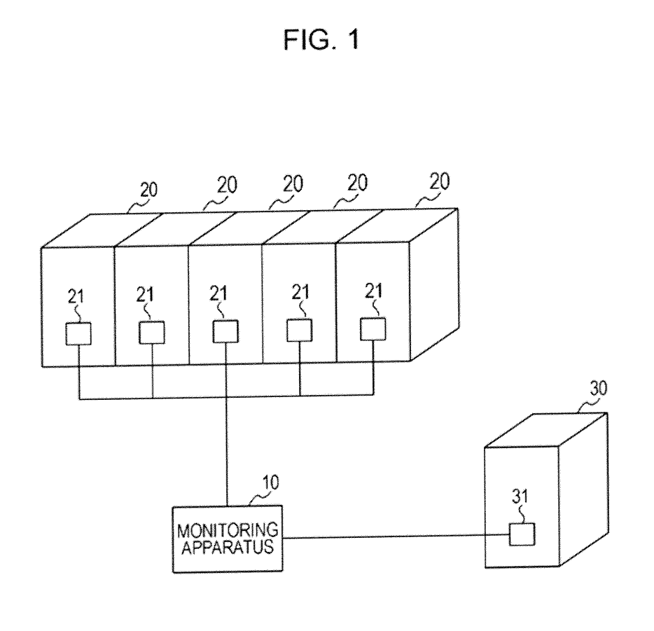

First, an example of a data center including a monitoring apparatus 10 according to the embodiment will be described. The data center illustrated in FIG. 1 includes the monitoring apparatus 10; one or more racks 20 housing a plurality of information processing apparatuses, and an air conditioner 30 which provides cooling air to the racks 20. The monitoring apparatus 10 is connected to a plurality of temperature sensors 21 included in the racks 20 and an air volume sensor 31 included in the air conditioner 30, and monitors an air conditioning state on the basis of measurement values of these sensors.

The data center illustrated in the example of FIG. 1 further includes other racks not illustrated in FIG. 1 and other air conditioners not illustrated in FIG. 1 providing cooling air to these racks.

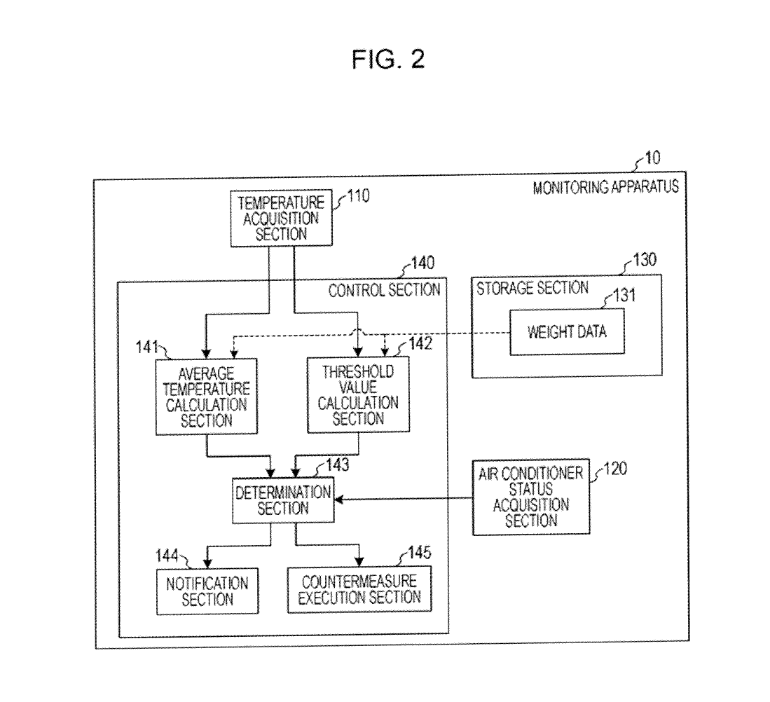

Next, a configuration of the monitoring apparatus 10 will be described with reference to FIG. 2. As illustrated in FIG. 2, the monitoring apparatus 10 includes a temperature acquisition section 110, an air conditioner status acquisition section 120, a storage section 130, and a control section 140. The temperature acquisition section 110 acquires temperatures measured by a plurality of temperature sensors 21.

The air conditioner status acquisition section 120 acquires an air volume measured by the air volume sensor 31. Information acquired by the air conditioner status acquisition section 120 only needs to be information by which an operation state of the air conditioner 30 can be determined, and for example, the information may be a rotation speed of a fan by which the air conditioner 30 blows cooling air.

The storage section 130 is a storage apparatus for storing various data, and stores weight data 131. The weight data 131 holds weights by which a weighted average described below is calculated while associating the weights with corresponding temperature sensors 21. The farther the corresponding temperature sensor 21 is located from a path in which more than a certain amount of exhaust air 2001 flows from the exhaust air 2001 side to the intake air 2000 side of the rack 20, the smaller the value of the weight held by the weight data 131 is set.

The control section 140 is a control section for entirely controlling the monitoring apparatus 10, and includes an average temperature calculation section 141, a threshold value calculation section 142, a determination section 143, a notification section 144, and a countermeasure execution section 145. The average temperature calculation section 141 calculates a weighted average of temperatures measured by the temperature sensors 21 by using the weights which are associated with the temperature sensors 21 and held in the weight data 131.

Specifically, when rises of temperature ΔTa to ΔTn are measured by n temperature sensors 21a to 21n, and weights Wa to Wn are associated with the temperature sensors 21a to 21n and held in the weight data 131, a weighted average G is calculated by using the following formula (1).

$$\begin{matrix}G = ( Δ Ta * Wa + … Δ Tn * Wn ) / n \\ = \sum ( Δ Ti \times Wi ) / n\end{matrix} \qquad Formula ( 1 )$$

The threshold value calculation section 142 calculates a threshold value for comparing with the weighted average calculated by the average temperature calculation section 141. Specifically, the threshold value calculation section 142 calculates an arithmetic average of temperatures measured by the temperature sensors 21 and an arithmetic average of weights which are associated with the temperature sensors 21 and held in the weight data 131. Then, the threshold value calculation section 142 obtains a threshold value by multiplying both arithmetic averages and adding a predetermined value d to the multiplication result.

When rises of temperature ΔTa to ΔTn are measured by n temperature sensors 21a to 21n, and weights Wa to Wn are associated with the temperature sensors 21a to 21n and held in the weight data 131, a threshold value TH is calculated by using the following formula (2).

$$\begin{matrix}TH = ( Δ Ta + … Δ Tn ) / n \times ( Wa + … Wn ) / n + d \\ = \sum ( Δ Ti ) / n \times \sum ( Wi ) / n + d\end{matrix} \qquad Formula ( 2 )$$

In this embodiment, although the rises of temperature ΔTa to ΔTn are assumed to be a difference from a temperature measured in a normal operation, the rises of temperature ΔTa to ΔTn may be a difference from a temperature measured by the same sensor at the previous time or a difference from an average of temperatures measured in the latest certain period. Instead of using the rises of temperature ΔTa to ΔTn, by using temperatures Ta to Tn measured by n temperature sensors 21a to 21n, the weighted average and the threshold value may be calculated.

The determination section 143 determines the air conditioning state on the basis of the weighted average calculated by the average temperature calculation section 141, the threshold value calculated by the threshold value calculation section 142, and the information indicating the operation state of the air conditioner 30 acquired by the air conditioner status acquisition section 120.

Specifically, the determination section 143 determines that the air conditioning is normal when the weighted average calculated by the average temperature calculation section 141 is smaller than a predetermined reference value. The determination section 143 determines that the air conditioning is abnormal when the weighted average calculated by the average temperature calculation section 141 is greater than or equal to the predetermined reference value.

To determine whether or not the air conditioning is normal, instead of the weighted average calculated by the average temperature calculation section 141, an average or maximum of the temperatures measured by the temperature sensors 21 may be used.

When the determination section 143 determines that the air conditioning is abnormal, the determination section 143 compares the weighted average calculated by the average temperature calculation section 141 and the threshold value calculated by the threshold value calculation section 142. When the weighted average is greater than the threshold value, the determination section 143 determines that an exhaust air 2001 circulation flow occurs. On the other hand, when the weighted average is smaller than or equal to the threshold value, the determination section 143 determines whether or not the abnormality is caused by the air conditioner on the basis of the information indicating the operation state of the air conditioner 30 acquired by the air conditioner status acquisition section 120.

When the determination section 143 determines that the air conditioning is abnormal, the notification section 144 notifies of the determination result of the determination section 143. For example, the notification section 144 performs the notification by displaying a warning text on a monitor viewed by a system administrator or sending an e-mail including the determination result to the system administrator. When the determination section 143 determines that the air conditioning is abnormal, the countermeasure execution section 145 executes a countermeasure in accordance with the determination result of the determination section 143.

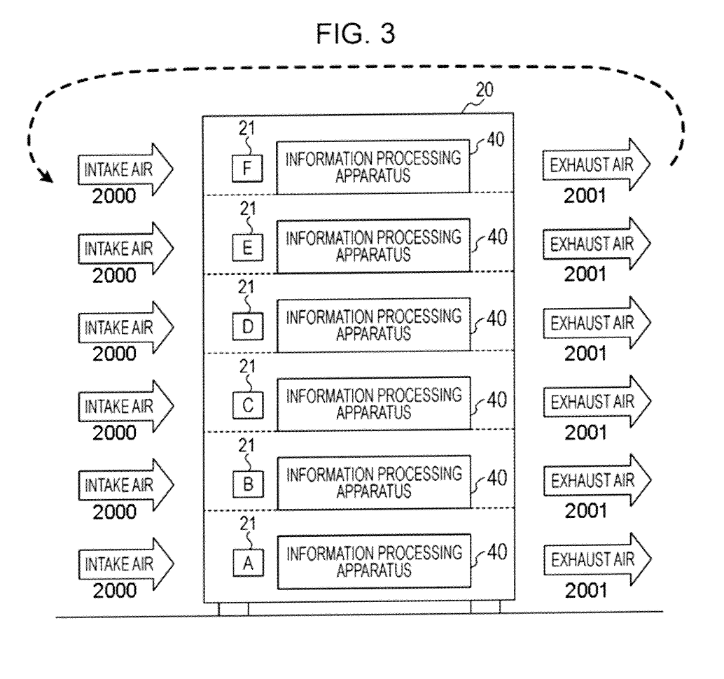

Next, the weights which are associated with the temperature sensors 21 and held in the weight data 131 and the determination of the abnormality of the air conditioning will be further described in detail with reference to a specific example. FIG. 3 is a diagram illustrating an example of the exhaust air 2001 circulation flow. In the example illustrated in FIG. 3, six information processing apparatuses 40 are mounted on the rack 20, and the temperature sensors 21 of A to F are arranged on the intake air 2000 side of each information processing apparatus 40.

In the case of the rack 20 illustrated in FIG. 3, since the gap between the floor and the rack 20 is small, there is little exhaust air 2001 circulating to the intake air 2000 side through the gap. On the other hand, since there is a large space between the top of the rack 20 and the ceiling, more than a certain amount of exhaust air 2001 flow may pass over the rack 20 and circulate to the intake air 2000 side. When the exhaust air 2001 circulates to the intake air 2000 side, air circulates while the air is heated by the information processing apparatus 40. Thus, temperature rises and various failures occur even when the air conditioner 30 operates normally.

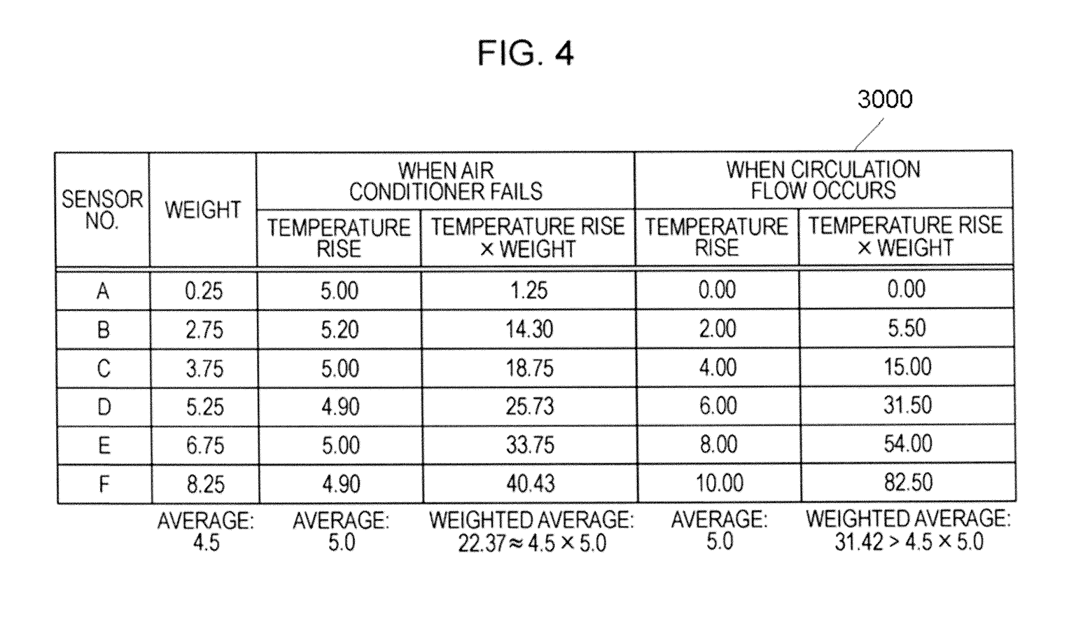

Therefore, to detect the exhaust air 2001 circulation flow, in the example illustrated in FIG. 3, as illustrated in a diagram 3000 of FIG. 4, the weights are set in the weight data 131 so that the larger the distance from the floor which is the farthest location from the path in which the exhaust air 2001 circulation flow may occur, the larger the weight is. In the example illustrated in FIG. 3, the temperature sensors 21 of A to F are sequentially arranged upward from the location near the floor in an order from A to F. Hence, in the example illustrated in the diagram 3000 of FIG. 4, the weight corresponding to the temperature sensor 21 of A is set to smallest, and the weight corresponding to the temperature sensor 21 of F is set to largest.

To set the weights so that the larger the distance from the floor, the larger the weight is, for example, the weight can be determined in accordance with the distance between the floor and the temperature sensor 21. In order to significantly increase the influence of the position of the temperature sensor 21, the weight may be determined on the basis of the square of the distance between the floor and the temperature sensor 21.

Here, it is assumed that the rises of temperature measured by the temperature sensors 21 when the air conditioner 30 fails and the rises of temperature measured by the temperature sensors 21 when the exhaust air 2001 circulation flow occurs are as illustrated in the diagram 3000 of FIG. 4. In this case, the arithmetic averages of the rises of temperature are “5.0” in both cases. Therefore, even when the arithmetic averages are calculated, whether the exhaust air 2001 circulation flow occurs or the air conditioner 30 fails cannot be determined.

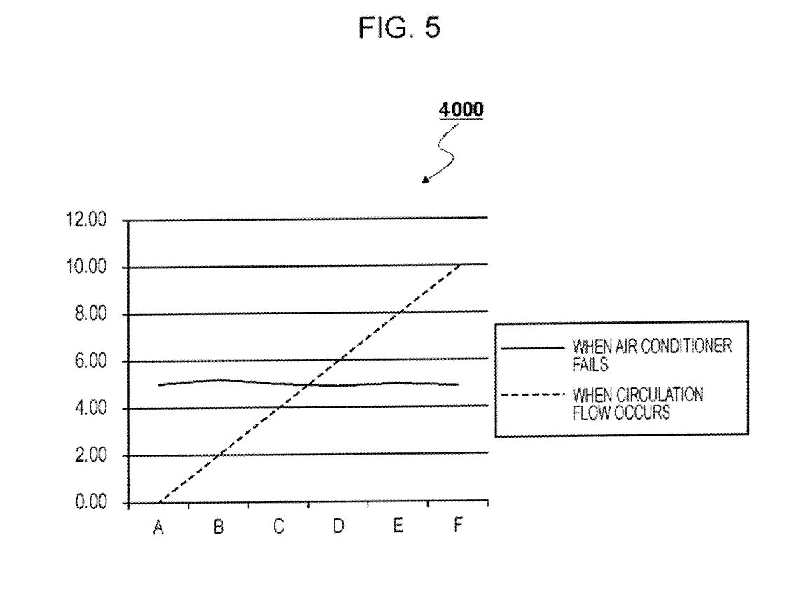

However, as obvious from the graph 4000 in FIG. 5, the temperatures measured by the temperature sensors 21 rise almost uniformly when the air conditioner 30 fails, while there is a tendency that the rise of temperature increases as the distance from the floor increases when the exhaust air 2001 circulation flow occurs. Therefore, as illustrated in the diagram 3000 of FIG. 4, when calculating the weighted average of the rises of temperature by using the weights which are set so that the larger the distance from the floor, the larger the weight is, it is possible to increase the above tendency and easily determine whether the exhaust air 2001 circulation flow occurs or the air conditioner 30 fails.

As illustrated in the diagram 3000 of FIG. 4, the weighted average of the rises of temperature is “22.37” when the air conditioner 30 fails, and this value almost corresponds to the value “22.5” which a value is obtained by multiplying the arithmetic average of the rises of temperature “5.0” by the arithmetic average of weights “4.5”. On the other hand, the weighted average of the rises of temperature is “31.42” when the exhaust air 2001 circulation flow occurs, and this value is much larger than the value “22.5” which is a value obtained by multiplying the arithmetic average of the rises of temperature by the arithmetic average of weights.

Therefore, when calculating the weighted average of the rises of temperature by using the formula (1), and comparing the weighted average with the threshold value which is obtained by adding a predetermined value d to the value obtained by multiplying the arithmetic average of the rises of temperature by the arithmetic average of weights as illustrated by the formula (2), it is possible to determine that the exhaust air 2001 circulation flow occurs when the weighted average is larger than the threshold value. The predetermined value d used here is a value to absorb the influence of variations of the temperatures measured by the temperature sensors 21. The value d may be a preliminarily fixed value or a value calculated by multiplying the value obtained by multiplying the arithmetic average of the rises of temperature by the arithmetic average of weights by a predetermined coefficient.

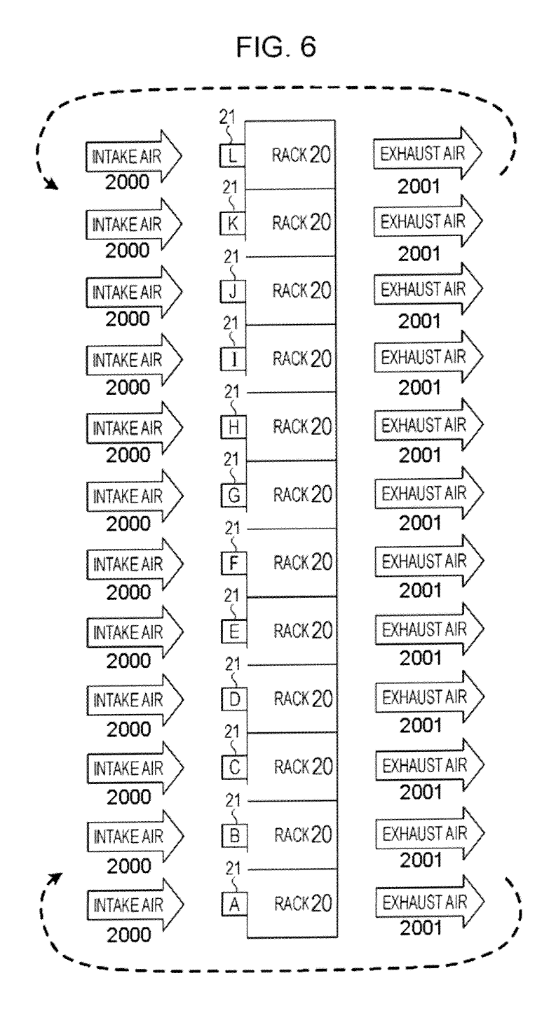

Although, in FIGS. 3 to 5, an example in which the exhaust air 2001 circulation flow occurs in the vertical direction, there is a case in which the exhaust air 2001 circulation flow occurs in the horizontal direction. The case in which the exhaust air 2001 circulation flow occurs in the horizontal direction will be described with reference to FIGS. 6 to 8.

FIG. 6 is a plan view of a state in which 12 racks are aligned in a row perpendicular to the intake air 2000/exhaust air 2001 direction, and the temperature sensors 21 of A to L are respectively provided to each rack. In this case, as illustrated in FIG. 6, more than a certain amount of exhaust air 2001 flow may pass beside the both ends of the row of the racks and circulate to the intake air 2000 side.

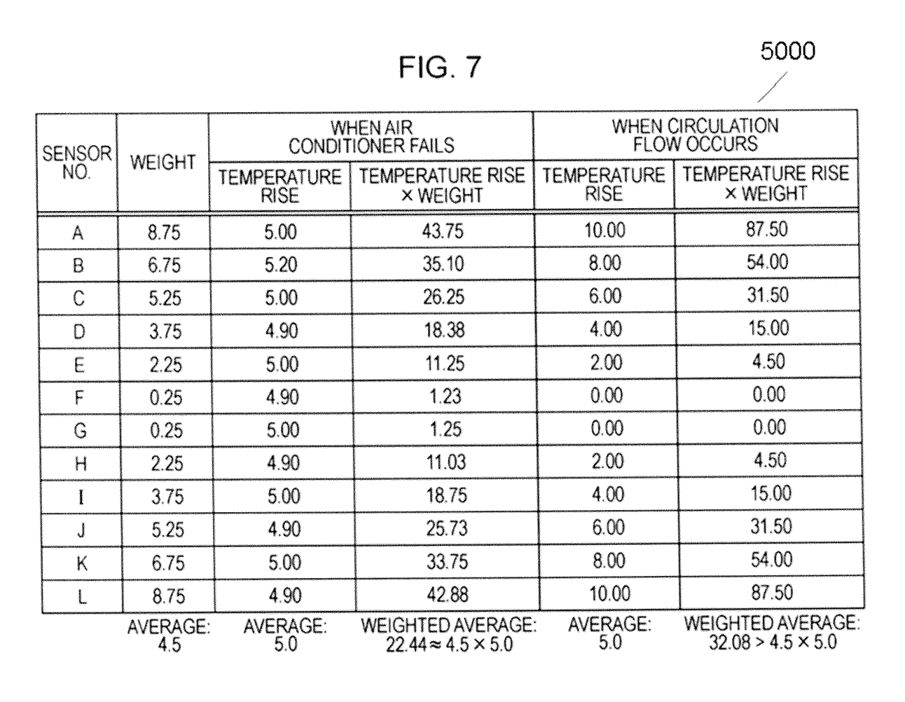

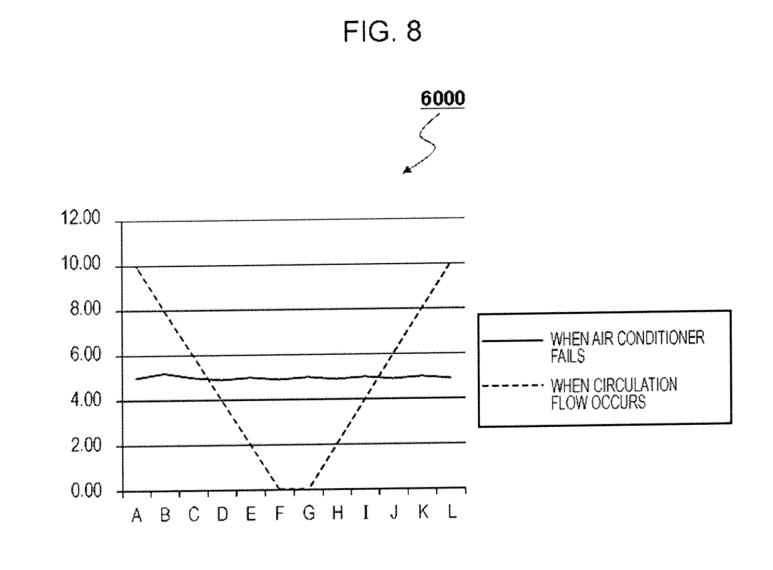

When an exhaust air 2001 circulation flow which passes beside the both ends of the row of the racks occurs, as illustrated in FIGS. 7 and 8, the nearer the rack is located to an end of the row of the racks, the larger the rise of temperature detected by the temperature sensor 21 provided in the rack is. Therefore, in the example illustrated in FIG. 6, the weights are set in the weight data 131 so that the larger the distance from the center of the row which is the farthest location from the path in which the exhaust air 2001 circulation flow may occur, the larger the weight is. In the example illustrated in a diagram 5000 of FIG. 7, the weights corresponding to the temperature sensors 21 of F and G which are nearest to the center of the row are set to smallest, and the weights corresponding to the temperature sensors 21 of A and L at the both ends of the row are set to largest.

To set the weights so that the larger the distance from the center of the row, the larger the weight is, for example, the weight can be determined in accordance with the distance between the center of the row and the temperature sensor 21. In order to significantly increase the influence of the position of the temperature sensor 21, the weight may be determined on the basis of the square of the distance between the center of the row and the temperature sensor 21.

By setting the weights in this way, in the example illustrated in the diagram 5000 of FIG. 7, the weighted average of the rises of temperature is “32.08” when the exhaust air 2001 circulation flow occurs, and this value is much larger than the value “22.5” which is a value obtained by multiplying the arithmetic average of the rises of temperature by the arithmetic average of weights.

The weights may be set so that the weights can be used in both cases of when the exhaust air 2001 circulation flow occurs in the vertical direction and when the exhaust air 2001 circulation flow occurs in the horizontal direction. In this case, for example, the temperature sensor 21 is provided to each information processing apparatus mounted on the racks aligned in a row, and the weights are set so that the larger the distance from the floor at the center of the row is, the larger the weight is.

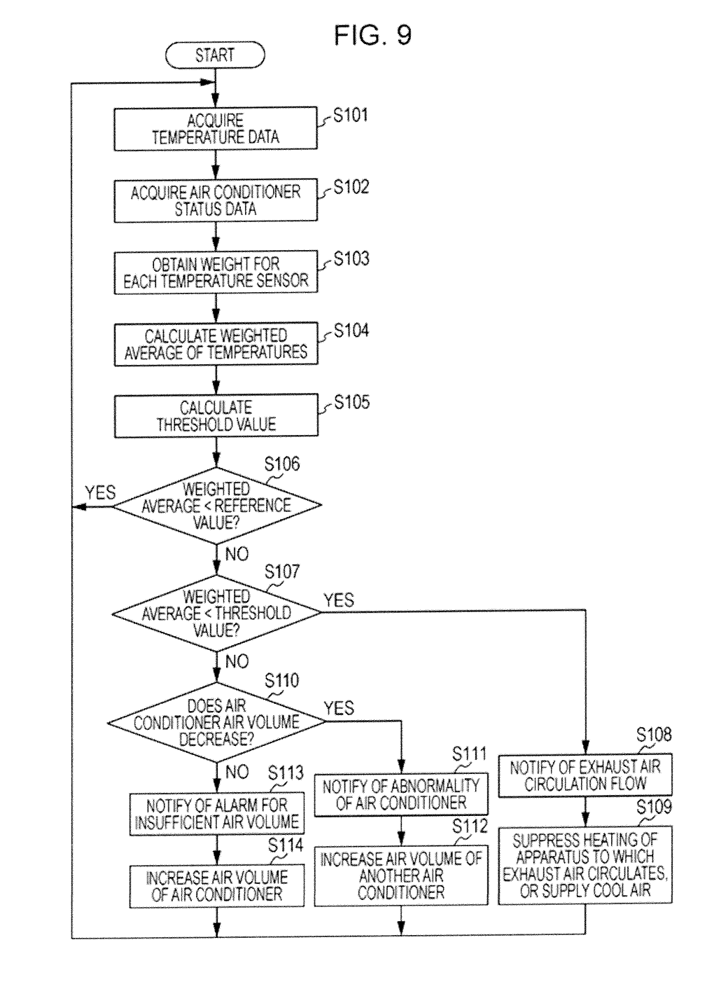

Next, a processing procedure of the temperature monitoring processing performed by the monitoring apparatus 10 will be described with reference to the flowchart in FIG. 9. As illustrated in flowchart of FIG. 9, in the monitoring apparatus 10, the temperature acquisition section 110 acquires temperature data measured by the temperature sensors 21 (step S101). The air conditioner status acquisition section 120 acquires air conditioner status data indicating the operation state of the air conditioner 30 from the air volume sensor 31 (step S102).

Subsequently, the average temperature calculation section 141 and the threshold value calculation section 142 read the weight data 131, and obtain weights corresponding to each temperature sensor 21 (step S103). Then, the average temperature calculation section 141 calculates the weighted average by using the formula (1) described above (step S104), and the threshold value calculation section 142 calculates the threshold value by using the formula (2) described above (step S105).

Here, when the weighted average is smaller than a predetermined reference value (step S106: Yes), the determination section 143 determines that there is no problem in the air conditioning, and the processing procedure is performed from step S101 again.

On the other hand, when the weighted average is larger than or equal to the predetermined reference value (step S106: No), the determination section 143 determines that there is an abnormality in the air conditioning, and identifies the cause of the abnormality as described below. When the weighted average is greater than the threshold value (step S107: Yes), the determination section 143 determines that the exhaust air 2001 circulation flow occurs, and the notification section 144 notifies of the occurrence of the exhaust air 2001 circulation flow (step S108). Then, the countermeasure execution section 145 executes a countermeasure such as suppressing heating of the information processing apparatus 40 to which the exhaust air 2001 circulates, or providing cooling air from underfloor through a louver to the information processing apparatus 40 to which the exhaust air 2001 circulates (step S109).

When the weighted average is smaller than or equal to the threshold value and air volume of the air conditioner 30 decreases (step S107: No, step S110: Yes), it is determined that an abnormality occurs in the air conditioner 30, and the notification section 144 notifies of the occurrence of abnormality (step S111). The countermeasure execution section 145 executes a countermeasure such as increasing air volume of another air conditioner (step S112).

When the weighted average is smaller than or equal to the threshold value and air volume of the air conditioner 30 does not decrease (step S107: No, step S110: No), it is determined that the air volume of the air conditioner 30 is insufficient, and the notification section 144 notifies of the insufficiency of the air volume (step S113). The countermeasure execution section 145 executes a countermeasure such as increasing the air volume of the air conditioner 30 (step S114).

The configuration of the monitoring apparatus 10 according to the embodiment illustrated in FIG. 2 can be variously modified without departing from the gist of the embodiment. For example, by implementing the function of the control section 140 of the monitoring apparatus 10 as software, and executing the software by a computer, it is possible to realize the same function as that of the monitoring apparatus 10. Hereinafter, an example of a computer that executes a monitoring program 1071 which is the function of the control section 140 implemented in the computer as software will be described.

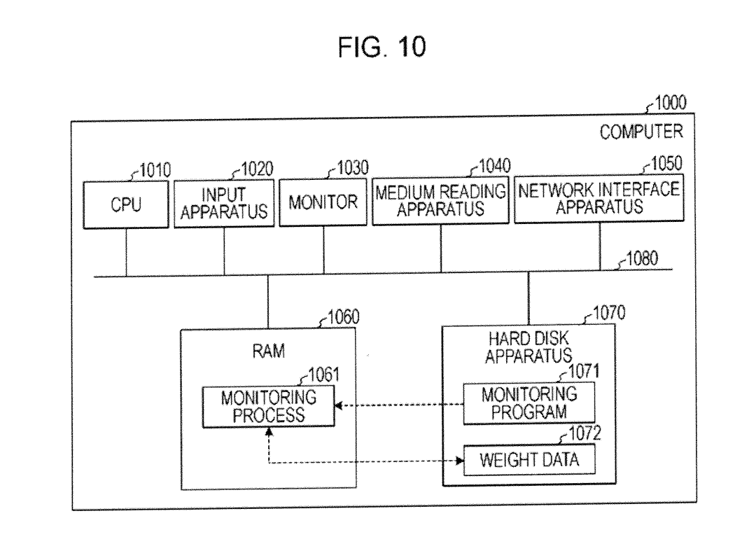

FIG. 10 is a functional block diagram illustrating the computer 1000 which executes the monitoring program 1071. The computer 1000 is configured to include a CPU (Central Processing Unit) 1010 that performs various calculations, an input apparatus 1020 that receives an input of data from a user, a monitor 1030 that displays various information, a medium reading apparatus 1040 that reads a program or the like from a recording medium, a network interface apparatus 1050 that transmits/receives data to/from another computer via a network, a RAM (Random Access Memory) 1060 that temporarily stores various information, and a hard disk apparatus 1070 which are connected to each other by a bus 1080.

In the hard disk apparatus 1070, the monitoring program 1071 having the same function as that of the control section 140 illustrated in FIG. 2 and the weight data 1072 corresponding to the weight data 131 illustrated in FIG. 2 are stored. The weight data 1072 can be appropriately distributed and stored in another computer connected via a network.

When the CPU 1010 reads the monitoring program 1071 from the hard disk apparatus 1070 and develops the monitoring program 1071 on the RAM 1060, the monitoring program 1071 functions as the monitoring process 1061. The monitoring process 1061 appropriately develops information read from the weight data 1072 in an area assigned to the monitoring process 1061 on the RAM 1060, and performs various data processing on the basis of the developed data.

The above monitoring program 1071 does not necessarily need to be stored in the hard disk apparatus 1070, and the computer 1000 may read the program stored in a storage medium such as a CD-ROM and execute the program. In addition, by storing the program in another computer (or server) connected to the computer 1000 via a public line, the Internet, LAN (Local Area Network), WAN (Wide Area Network), or the like, the computer 1000 may read the program from the computer (or server) and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An abnormality detection apparatus for detecting abnormality of air conditioning in a room which accommodates a plurality of computers having an air inlet and having an outlet, comprising:
a plurality of temperature detectors for detecting temperatures at each of the air inlets;
a memory for storing a plurality of reference patterns, each of the reference patterns representing a set of temperatures at each of the air inlets and corresponding to one of a plurality of abnormal categories;
a determining unit for determining one of the abnormal categories by comparing the detected temperatures by the temperature detectors with the reference patterns stored in the memory;
an output unit for outputting information corresponding to the category of the air condition abnormality determined.

2. The abnormality detection apparatus according to claim 1, wherein
one of the reference patterns stored in the memory represents a set of abnormal values of same temperature related to breakdown of an air conditioner.

3. The abnormality detection apparatus according to claim 1, wherein
the plurality of the computers are accommodated in a line, and
one of the reference patterns stored in the memory represents one of the set of temperature at each of the inlets related to an abnormal flow at end of the line, the one of the set of temperatures including a first temperature at the inlet of the computer accommodated on the edge of the line and a second temperature at one of the other inlets, the first temperature being higher than above the second temperature.

4. An abnormality detection method for detecting abnormality of air conditioning in a room which accommodates a plurality of computers having an air inlet and having an outlet, comprising:
determining one of the abnormal categories by comparing the detected temperatures with a plurality of reference patterns stored in a memory, the memory storing the plurality of the reference patterns, each of the reference patterns representing a set of temperatures at each of the air inlets and corresponding to one of a plurality of abnormal categories;
outputting information corresponding to the category of the air condition abnormality determined.

5. The abnormality detection method according to claim 4, wherein
one of the reference patterns stored in the memory represents a set of abnormal values of same temperature related to breakdown of an air conditioner.

6. The abnormality detection method according to claim 4, wherein
the plurality of the computers are accommodated in a line, and
one of the reference patterns stored in the memory represents one of the set of temperature at each of the inlets related to an abnormal flow at end of the line, the one of the set of temperatures including a first temperature at the inlet of the computer accommodated on the edge of the line and a second temperature at one of the other inlets, the first temperature being higher than above the second temperature.

7. A computer-readable recording medium storing a computer program for detecting abnormality of air conditioning in a room which accommodates a plurality of computers having an air inlet and having an outlet, the program being designed to make a computer perform the steps of:
determining one of the abnormal categories by comparing the detected temperatures with a plurality of reference patterns stored in a memory, the memory storing the plurality of the reference patterns, each of the reference patterns representing a set of temperatures at each of the air inlets and corresponding to one of a plurality of abnormal categories;
outputting information corresponding to the category of the air condition abnormality determined.

8. The computer-readable recording medium storing a computer program according to claim 7, wherein
one of the reference patterns stored in the memory represents a set of abnormal values of same temperature related to breakdown of an air conditioner.

9. The computer-readable recording medium storing a computer program according to claim 7, wherein
the plurality of the computers are accommodated in a line, and
one of the reference patterns stored in the memory represents one of the set of temperature at each of the inlets related to an abnormal flow at end of the line, the one of the set of temperatures including a first temperature at the inlet of the computer accommodated on the edge of the line and a second temperature at one of the other inlets, the first temperature being higher than above the second temperature.
